(19) United States
(12) Patent Application Publication
(10) Pub. No.: US 2010/0186892 A1
(43) Pub. Date: Jul. 29, 2010

(54) ELECTROSTATICALLY APPLYING A LABEL TO A MOLD CAVITY

(76) Inventor: Mark Blitshteyn, New Hartford, CT (US)

Correspondence Address: Anthony M Palazzolo Jr;The Law Office of Anthony Palazzolo Jr, 285 Pendleton Hill Road, North Stonington, CT, 06359, US

(21) Appl. No.: 12/451,445

(22) PCT Filed: May 14, 2008
(86) PCT No.: PCT/US08/06145

§ 371 Date: Nov. 13, 2009

Related U.S. Application Data
(60) Provisional application No. 60/930,238, filed on May 15, 2007.

(51) Int. Cl. B29C 65/00; B29C 65/14

(52) U.S. Cl. 156/273.1; 156/379.8

(57) ABSTRACT

The disclosure describes the use of electrostatics to in-mold labeling wherein a label is secured to a mandrel with an axis-defining body, a first end, a distal end, a set of ionizing electrodes disposed about the body, near the distal end, and in a plane perpendicular to the axis. When the mandrel is positioned in a mold cavity, the label is released and a varying voltage applied to the electrodes to form a substantially uniform and ring-like source of ionizing current. The ionizing current progressively pins the label against the die as the mandrel is withdrawn from the die until substantially the entire label is pinned. The ionizing current may then be ended and the mandrel removed so that an article may then be formed into the label.

### CROSS REFERENCE TO RELATED CASES

This application claims the benefit under 35 U.S.C. 119(e) of co-pending U.S. Provisional Application(s) Ser. No. 60/930,238 filed May 15, 2007 and entitled “Electrostatically Applying a Label to a Mold Cavity”; which Provisional Application is hereby incorporated by reference.

### BACKGROUND OF THE INVENTION

1. Field of the Invention

The present invention is directed to systems, processes and apparatus for use in manufacturing molded articles having integrally formed labels. More particularly, the invention relates to the use of electrostatics to improve the quality and efficiency of the aforementioned manufacturing processes. Accordingly, the general objects of the invention are to provide novel systems, methods and apparatus of such character.

2. Description of the Related Art

“In-Mold Labeling” has become increasingly popular in recent years and generally includes applying a label to the wall of the mold (die) cavity, closing the mold cavity and injecting plastic. This manufacturing technique can be used to make a wide variety of items including, pots, beakers, trays, buckets, etc. of almost any conceivable shape. Applying the label during molding eliminates a secondary step for pad or screen-printing, label application, etc. because the label becomes an integral part of the molded article. More importantly, the end result is permanent. This makes it especially attractive for product-liability and instructional information, as well as UPC codes, logos, and decoration.

Although in-mold labeling presents many technical challenges, one of the most difficult is how the label is held in place during injection of the plasticized material. The two label-holding techniques that are presently in use rely on either a vacuum and/or electrostatics and each of these techniques faces a different set of problems.

It is known that a label can be held in the desired location in the mold by specially designed and machined vacuum ports. In such systems, an automated machine typically picks up a label of suitable material from a magazine using a mandrel with vacuum ports incorporated therein and places it in the proper position in the female mold cavity. The vacuum of the mandrel is then turned off. The vacuum of the die is turned on and the mandrel is removed from the die cavity. Finally, the mold is shot.

In some applications, electrostatics offers a more reliable and cost-effective alternative to the use of a vacuum for holding the label in its proper location in the die/cavity. In one typical electrostatic process, an automated machine picks up a label from the magazine using a mandrel with vacuum ports and holes incorporated therein. While the label is being held by the mandrel, a static charge is placed on the label as the mandrel with the label approaches the mold. When the mandrel and label have been placed into the mold cavity, the mandrel vacuum is released and the label is transferred to the surface of the die due to electrostatic forces. No vacuum in the die or adhesive on the label is needed. In a variant of this process, the mandrel includes electrodes throughout and these electrodes may be energized after the mandrel vacuum has been released. In this variant process, when the mandrel and label have been placed into the mold cavity, the mandrel vacuum is released and, vacuum holes provide a “puff” of compressed air to assist the label transfer to the surface. The electrodes produce ionizing current to charge the entire label. The resulting electrostatic field “pins” the entire label against the mold cavity substantially instantaneously. The mandrel then is withdrawn from the female cavity and the mold is shot.

Molded parts with a cylindrical, conical or tapered shape present a special set of challenges. Some recent efforts in the field of in-mold labeling have focused on such shapes and include the various devices and techniques described in the following U.S. Patents and published Applications: U.S. Pat. No. 3,602,496, issued Aug. 31, 1971, entitled “Apparatus For Manipulating Labels Or The Like”, (the entire contents of which are hereby incorporated by reference); U.S. Pat. No. 6,007,759, issued Dec. 28, 1999, entitled “Method For Manufacturing An Injection Moulded Article”, (the entire contents of which are hereby incorporated by reference); and US 2007/0042144, U.S. Ser. No. 11/506,818, filed Aug. 18, 2006 and published Feb. 22, 2007, entitled Labeled Containers, Methods And Devices For Making Same (the entire contents of which are hereby incorporated by reference). Various specialized devices and techniques of this nature are also described in the following magazine publication: Plastics Technology, In-Mold Labeling, Electrostatics Are the Way to Go, Scott E. Shelton (April 2004).

While the aforementioned apparatus and techniques have improved certain aspects of the state of this art, there remain various aspects of the art that are still poorly understood. Consequently, conventional in-mold labeling processes and apparatus can still only provide satisfactory results when many diverse factors discussed below (such as material composition, tolerances and dimensions, timing, temperatures, etc) are precisely controlled.

### SUMMARY OF THE INVENTION

The present invention satisfies the above-stated needs and overcomes the above-stated and other deficiencies of the related art by providing novel methods, systems and apparatus for applying electrostatics to in-mold labeling apparatus and techniques. In accordance with the invention a label is secured to a surface of an electrostatic mandrel body that includes a first end, an opposite distal end, and ionizing electrodes in the vicinity of the distal end of the mandrel body. The mandrel body is then positioned within a female mold cavity and the label is released from the mandrel. A high voltage is then supplied to the electrodes to produce ionizing current and charge the label to electrostatically pin the label to the female mold cavity in the vicinity of the ionizing electrodes. As the mandrel is progressively withdrawn from the female mold cavity, more of the label is electrostatically pinned to the mold cavity until substantially the entire label has been pinned to the cavity. Once the entire label has been pinned, the high voltage may be turned off and a labeled article may then be formed using injection molding. The power supply may be capable of supplying a varying high voltage that is delivered to the electrodes to thereby produce a constant ionizing current, even if the distance to between the electrodes and the mold cavity varies.

A related form of the invention is directed to an electrostatic mandrel capable of positioning a label in a mold. The inventive mandrel may include an axis-defining body with a first end, an opposite distal end, a set of ionizing electrodes at least near the distal end and a means for delivering a varying high voltage to the electrodes. In this form of the invention, an optional feature includes a groove, recess, or trough disposed about the body and in a plane that is at least substantially perpendicular to the axis. The groove may be located at or near the distal end of the mandrel and the set of ionizing electrodes may include plural ionizing electrodes with ionizing tips positioned within the mandrel groove. When an appropriate high voltage is applied to the electrodes, a substantially uniform ionizing current may be emitted from the electrodes around the entire circumference of the mandrel. In some apparatus embodiments of the invention the aforementioned components may be formed as a single unit that may be replaced as a whole as desired. In other apparatus embodiments the electrodes may be formed as a removable/replaceable unit that mates with the remainder of the mandrel; this arrangement may permit replacement of a worn electrode unit while permitting reuse of some or all of the rest of the mandrel.

Naturally, the above-described methods of the invention are particularly well adapted for use with the above-described apparatus of the invention. Similarly, the apparatus of the invention are well suited to perform the inventive methods described herein.

Numerous other advantages and features of the present invention will become apparent to those of ordinary skill in the art from the following detailed description of the preferred embodiments, from the claims and from the accompanying drawings.

### BRIEF DESCRIPTION OF THE DRAWINGS

The preferred embodiments of the present invention will be described below with reference to the accompanying drawings where like numerals represent like steps and/or structures and wherein:

FIG. 1 is a perspective view of an electrostatic mandrel in accordance with one preferred embodiment of the present invention;

FIG. 2 shows the electrostatic mandrel of FIG. 1 wherein a label has been applied to the mandrel in preparation for placement into a mold cavity;

FIG. 3 is a side elevation view of the electrostatic mandrel of FIG. 1;

FIG. 3a is a side elevation of an electrostatic mandrel in accordance with an alternative preferred embodiment of the present invention;

FIG. 3b is a side elevation of the electrostatic mandrel of FIG. 3a wherein a label has been applied to the mandrel in preparation for placement into a mold cavity;

FIGS. 4a-4d depict four different section view taken along the section line S-S of either FIG. 3 or FIG. 3a, wherein the different embodiments employ different sets of ionizing electrodes and the arrangements for delivering voltage to the electrodes

FIGS. 5a-5e schematically illustrate one preferred method embodiment of the present invention compatible with any one of the electrostatic mandrels of FIGS. 1-4d;

FIGS. 6a, 6b and 6c depict the process of withdrawing an inventive mandrel from a female mold cavity wherein the distance between the electrode tips and the cavity wall changes and wherein the voltage applied to the electrodes varies to thereby maintain a constant ionizing current;

FIG. 7a illustrates a representative relationship between the electrode supply voltage and the distance between the electrode tips and a mold cavity wall during the process of FIGS. 6a-6c; and

FIG. 7b illustrates a representative relationship between the ionizing current and the distance between the electrode tips and a mold cavity wall during the process of FIGS. 6a-6c.

### DETAILED DESCRIPTION OF THE PREFERRED EMBODIMENTS

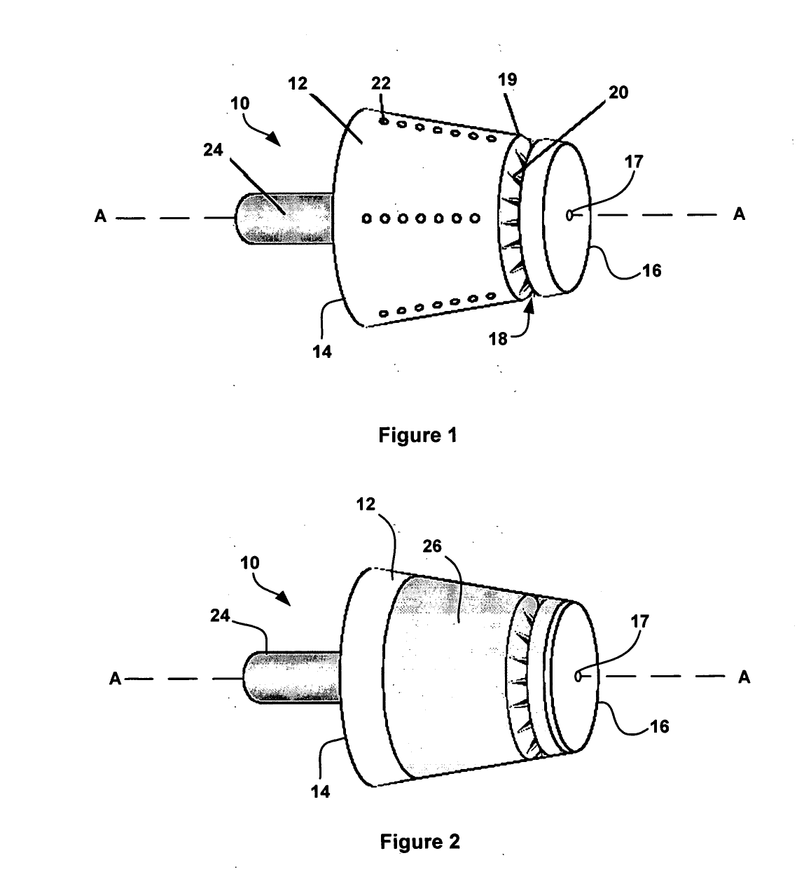

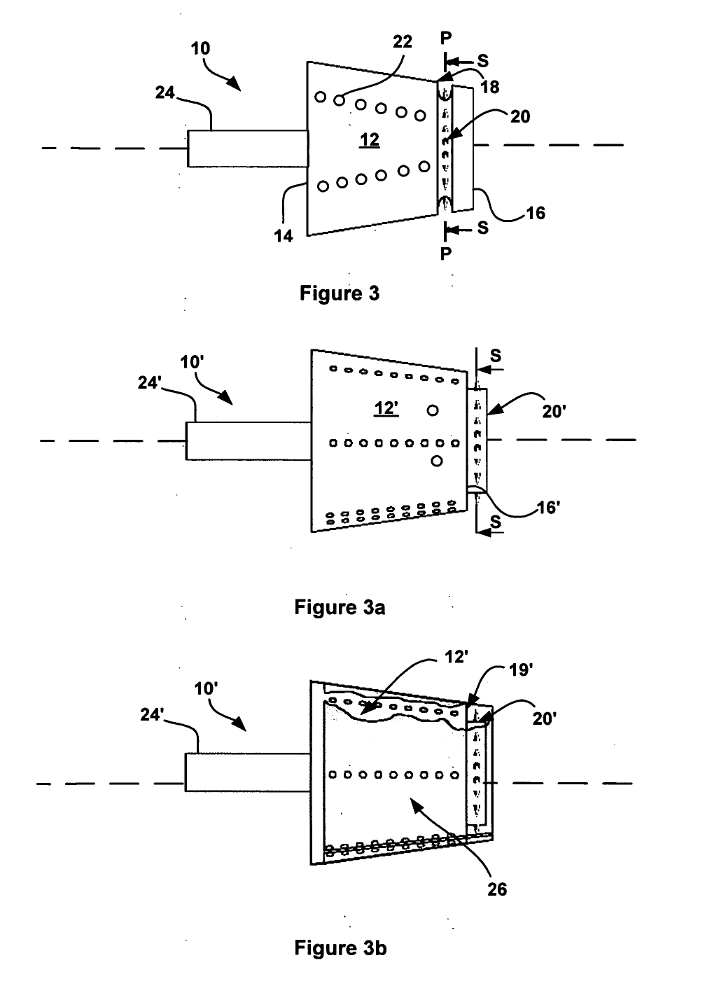

With primary reference to FIG. 1, a first preferred embodiment of the present invention is directed to an electrostatic mandrel 10 capable of positioning a label in a female mold cavity. The mandrel may include a body 12 (that defines an axis A), with a first end 14 and an opposite distal end 16, a set of ionizing electrodes 20, a groove 18 disposed about body 12 and in a plane P (see FIG. 3) that is at least substantially perpendicular to axis A. Mandrel 12 may, optionally, also include an axially aligned guide shaft to facilitate compatibility with conventional in-mold labeling apparatus. In this form of the invention, groove 18 is located near distal end 16 of mandrel 10 and set of ionizing electrodes 20 includes plural ionizing electrodes with ionizing tips positioned within mandrel groove 18 (below the surface of body 12). When an appropriate high voltage is applied to electrode set 20, a substantially uniform ionizing current is emitted from the electrodes 20 in the groove 18 in the vicinity of distal end 16 around the entire circumference of the mandrel. Unlike the prior art described above, there is substantially no other ionizing current emanating from mandrel 10. Therefore, the ionizing current is progressively applied to a label as the inventive mandrel is withdrawn from a mold cavity as discussed in greater detail below.

As best seen in FIGS. 1 and 2, mandrel 10 includes structure for securing a label 26 to mandrel 10 prior to insertion into a female mold cavity. While other conventional methods and structures may be employed to temporarily secure label 26, this embodiment preferably employs a plurality of internal vacuum ports (not shown) and plural surface holes 22 for this purpose. The ports preferably extend through guide shaft 24, through the interior of body 12, and to vacuum holes 22 located on the surface of body 12. Significantly, however, the invention specifically envisions no vacuum holes 22 located between any of the electrodes 20. This enables higher electrode pin densities that are important for providing a uniform electrostatic field when the electrodes are energized. Moreover, the invention envisions that there be only one ring-like set of ionizing electrodes in mandrel 10. This is preferably achieved with only one electrode groove/recess 18 and only one set of electrodes 20 disposed therein. It will also be appreciated that each of electrodes 20 may be positioned within its own recess (with the recesses collectively encircling body 12) instead of all of the electrodes 20 being disposed within a single groove. Since this configuration is functionally equivalent to the preferred groove 18, it too shall be referred to as a groove or trough in the parlance of this specification and the appended claims.

Because, in the embodiment being discussed, body 12 is frusto-conical, groove 18 happens to be a circumferential groove, trough or recess and electrodes 20 are positioned in that circumferential groove such that the electrode tips are about ¼″ (one-quarter inch) from the outer edge of groove 18 (this is also the surface of body 12). However, this distance may vary depending on a number of factors such as label material, label thickness, the size and geometry of groove 18, and the geometry and the taper angle of body 12. Thus, this distance may be anywhere from ⅛″ (one-eighth inch) to 1″ (one inch) from the outer edge of the groove. Groove 18 is preferably uniform and may be u-shaped, v-shaped, etc. in cross-section. It may have curved or linear walls in cross-section. If linear, the walls may taper outwardly at about 45 degrees relative to the plane of electrodes 20. If the mandrel is formed of multiple components removably affixed to one another (as opposed to being integrally formed), there will be an interface 19 which may be located on either end of groove 18 or in the middle of groove 18. Regardless of the particular shape or size of groove 18, it does not appreciably interfere with ion flow to the label.

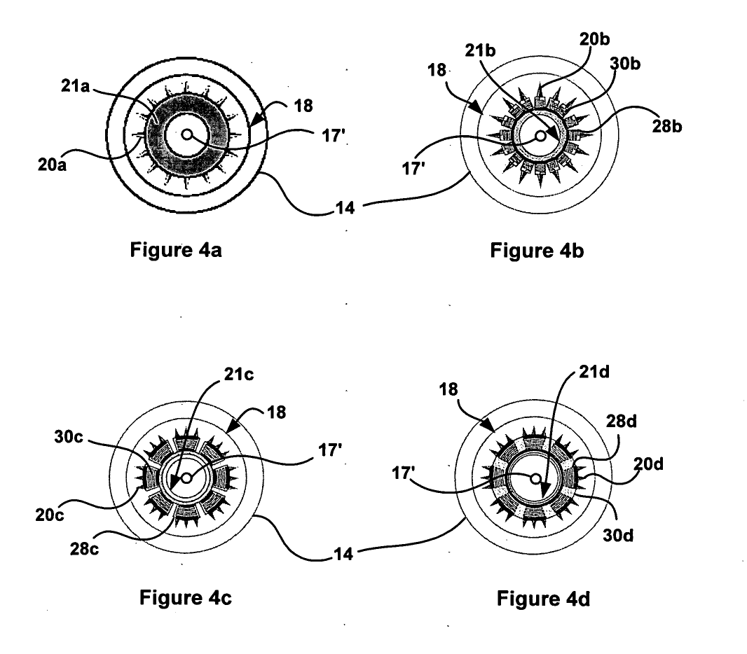

In an alternate embodiment shown in FIGS. 3a and 3b, electrodes 20′ and groove/recess/trough 18 (with an I-shaped cross-section) are positioned at distal end 16 of mandrel body 12. One advantage of this arrangement is that electrodes 20′ are located at the very end of the mandrel so that the electrode pins are substantially aligned with the very bottom edge of label 26. The alternate embodiments of FIGS. 3a and 3b also offer mandrel manufacturing and repair advantages because it permits the electrode assemblies to be either integrally formed with the mandrel body during manufacture or formed as a removable electrode assembly cartridge 20′ that may be affixed to or removed from the mandrel body 12 as desired. As shown therein, electrode assembly cartridge 20′ may mate against distal end 16 of body 12 at interface 19 and cartridge 20′ may be affixed thereto using any one or more of a wide variety of known structures (see screws/screw-holes 17 or 17′ in FIGS. 1, 2, and 4a-4d) such as screws, bolts, nuts, spring-loading arrangements, press-fitting arrangements, crimping techniques, glues, snap-fitting arrangements, etc. However, it is preferable to use a removable form of affixation to permit fast and simple cartridge replacement techniques (thus, providing a simple and inexpensive repair option) because it is envisioned that a durable mandrel may, last much longer than a set of electrodes. As discussed below with respect to FIGS. 4a-4c, appropriate voltages may be provided through wiring passing through mandrel body 12. While electrode cartridges 20′ may be hardwired via this wiring, the embodiments of FIGS. 3a and 3b are preferably provided with one of the many known forms of electrical connectors for connecting and/or disconnecting the electrode cartridges as desired. It will be appreciated that the embodiments of FIGS. 3a and 3b will be simpler and cheaper to manufacture than the electrostatic mandrels of the prior art because the electrodes and associated wiring of the prior art must be installed in various locations throughout a given mandrel. In contrast, the inventive electrode cartridges 20′ may be assembled separately from the mandrel body and then affixed and wired thereto in one location.

The preferred electrode spacing is determined based on a number of factors such as the size and geometry of mandrel body 12 and the complementary mold cavity with which it may be used, the type and thickness of label 26, the type and thickness of the plastic to be molded to label 26, etc. It has been discovered that, in many applications, the tips of electrodes 20 are preferably evenly spaced within mandrel groove 18 and spaced from adjacent tips by about 0.1″ to about 1″. In particular, electrode tip spacing should be selected to provide a substantially uniform charging of the label around the circumference of mandrel body 12. Whereas higher pin densities are possible using the electrodes discussed herein, it has been found that higher pin densities are beneficial when the pins are in close proximity to the mold cavity and that lower pin densities are sufficient when the pins are further from the mold die/cavity.

As has been noted, in the various preferred embodiments, the electrode arrangement provides near-uniform charging around the circumference of the label/mold cavity at the edge of label 26 closest to the truncated distal end 16 of body 12. This is especially important when the mold gates, which inject plastic into a mold cavity, are positioned near distal end 16 of mandrel body 12 when injection begins because there is an increased risk of the plastic dislodging label 26 or flowing between label 26 and the mold cavity wall. Additional benefits of this electrode arrangement will become still clearer in light of the discussion below.

Mandrel 10 may be made substantially entirely of a nonconductive material such as PE, PTFE, PVC, acrylic or other plastic material. Alternatively, mandrel 10 may be largely formed of a conductive material, such as aluminum or steel, as long as the electrodes are sufficiently spaced from the edge of the metal portion of the mandrel body to substantially prevent arcing. In some or all of the embodiments shown and described herein, the ionizing electrodes 20 or 20′ may be incorporated in the mandrel body structure in a number of conventional ways such as integrally forming the electrodes with body 18 using an appropriate epoxy, etc. Electrodes 20 or 20′ may, alternatively, be removably affixed to a mandrel body at interface 19 or 19′ as shown and described herein. Mandrel body 12 may be shaped as a truncated cone (as shown) and ionizing electrodes 20 placed in a circular pattern in groove 18 circling around the circumference of body 12 at distal end 16. In use, this corresponds with the bottom of the article to be molded such that label 26, when placed around the mandrel, covers electrodes 20. The set of ionizing electrodes 20 may be electrically coupled to the high voltage source in at least two different ways: direct coupling and resistive coupling. The directly coupled electrodes have a tendency to arc to the, typically, metal surface of the mold if the voltage applied to the electrodes 20 is too high or the distance to the surface of the mold is too small. As shown and discussed in greater detail below, the resistively-coupled electrodes are connected to the high voltage source individually or in groups via one or more high-voltage high-value resistors (and optionally a bus). These resistors suppress arcing from the electrodes 20 to the female mold cavity. This permits the application of high voltage to the electrodes and stronger electrostatic pinning of label 26 to the mold.

It is envisioned that the invention will apply to virtually any mold/mandrel arrangement with a concave mold and a complementary convex mandrel body. Thus, by way of example only, mandrel body 12 may be in the form of a cone, a pyramid, a half-sphere, an ellipsoid, a paraboloid segment, etc. Additionally, it is envisioned that the invention will apply to mandrel bodies like those noted immediately-above, but which have been truncated at the smaller end (such as the frustum of a pyramid or cone, etc). Further, mandrel body 12 may be virtually any other convex shape.

Where the invention is applied to any of these body shapes, the electrode tips may be arranged such that they are substantially the same shape as mandrel body 12 in the vicinity of groove 16 in which electrodes 20 may be embedded. Restated, the cross-sectional shape of mandrel body in the vicinity of the electrodes 20 is preferably substantially the same shape as that defined by the arrangement of electrode tips. For example, the electrode tips may form a circle when the mandrel body is conical or an ellipsoid, etc.

The physical and electrical characteristics of the labels that may be used in conjunction with the invention are well known in the art and no special labels are required. Thus, the invention is compatible with many of the labels commonly used in conventional systems. The surface of such labels are good insulators so that such labels may accept and maintain the static charges that pin them to mold cavities in use. Preferably, this surface should have a resistivity of 10¹² ohms/sq or greater. The higher the resistivity, the better the label will accept the charge without bleeding the charge to ground when it contacts a mold cavity. If the charge is not maintained when in contact with the die, adhesion may be lost and the label may slip from the intended position. Label properties such as thickness, curl, and surface texture also affect adhesion. For example, a textured label or die surface may make good adhesion more difficult due to the reduction in intimate surface contact between the label and cavity surface. A relatively thin, non-textured label with good dielectric properties on a non-textured die surface typically produces the best results.

Several preferred ionizing electrode arrangements and the arrangements for delivering voltage to the electrodes are shown in the sectional views taken along line S-S of FIGS. 3 and 3a presented in FIGS. 4a-4d. These Figures illustrate, inter alfa, several preferred electrode arrangements and configurations for delivering appropriate ionizing voltages to the electrodes 20. Power supply should preferably be able to provide a minimum of about 5 kV output voltage and about 0.5 mA current for small objects and should preferably be able to provide up to about 30 kV output voltage and about 1 mA current for larger molded objects.

FIG. 4a illustrates a preferred embodiment of the invention in which the ionizing electrodes 20a are all electrically coupled to a single bus ring 21a which, in turn, is coupled to a source of high voltage directly a through a single resistor (not shown). A connector or wire may make electrical contact with electrode bus ring 21a inside the mandrel and, therefore, serve to electrically couple electrodes 20 with an appropriate, preferably a constant-current, power supply.

FIG. 4b illustrates a preferred embodiment of the invention in which ionizing electrodes 20b are individually coupled to a single bus ring 21b through resistors 28b on multiple separate substrates 30b (the electrode pin assemblies preferably used herein may be similar to the conventional electrode pin assemblies used in MKS, Ion Industrial charging bar Model 7401). A connector or wire may make electrical contact with electrode bus ring 21b inside the mandrel and, therefore, serve to electrically couple electrodes 20 with an appropriate, preferably a constant-current, power supply.

FIG. 4c illustrates yet another preferred embodiment of the invention in which the ionizing electrodes 20c are coupled in groups to a single bus ring 21c through group-resistors 28c on multiple separate substrates 30c (the electrode pin assemblies preferably used herein may be similar to the conventional electrode pin assemblies used in MKS, Ion Industrial charging bar Model 7430. A connector or wire may make electrical contact with electrode bus ring 21c inside the mandrel and, therefore, serve to electrically couple electrodes 20 with an appropriate, preferably a constant-current, power supply.

FIG. 4d illustrates a preferred embodiment of the invention in which the ionizing electrodes 20d are coupled in groups to a single bus ring 21d through group-resistors 28d on a single common substrate 30d. A connector or wire may make electrical contact with electrode bus ring 21d inside the mandrel and, therefore, serve to electrically couple electrodes 20 with an appropriate, preferably a constant-current, power supply. It is noted that, inter alia, the electrode arrangements of FIGS. 4c and 4d permit greater pin densities than do the electrode arrangement of FIG. 4b.

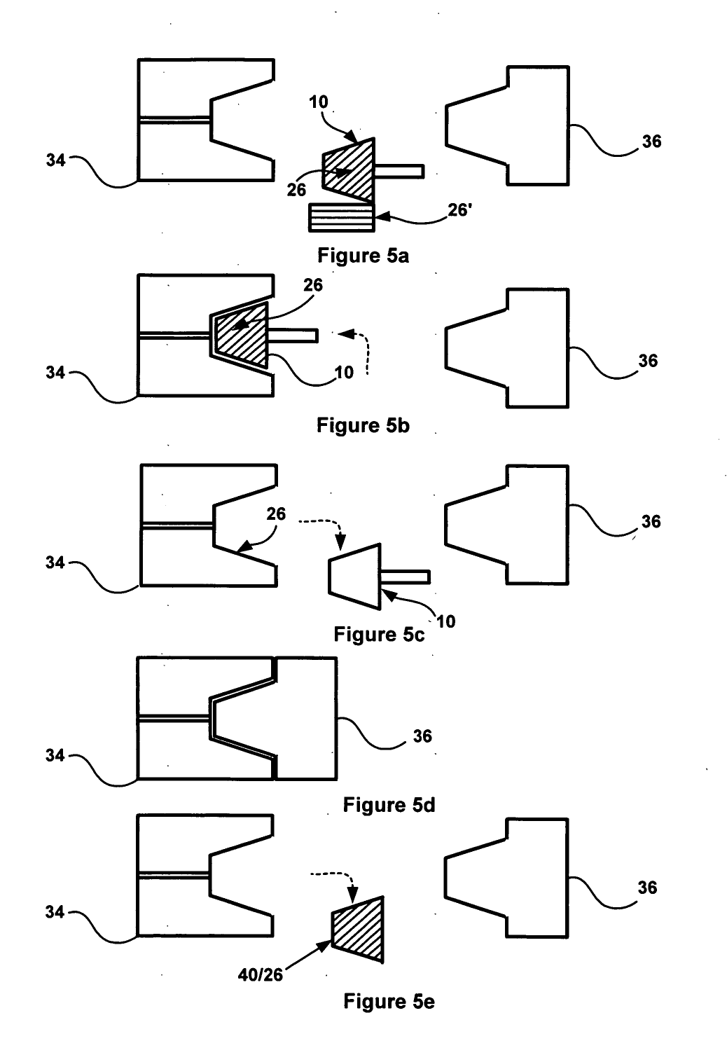

Preferred methods of electrostatically placing a label into a mold cavity and of producing a labeled article in accordance with the invention will now be described with respect to FIGS. 5a-5e. The preferred method embodiment may begin with the provision of an appropriate electrostatic mandrel and application of an appropriate label 26 thereto from a label magazine 26′ (see FIG. 5a). When mandrel body 12 with label 26 secured thereto is fully inserted into a female mold cavity 34, the controls of the system release the vacuum, and vacuum holes may provide a “puff” of compressed air to assist the label transfer to the surface releasing label 26 from body 12. Label 26 is then ready for transfer to the mold (see FIG. 5b).

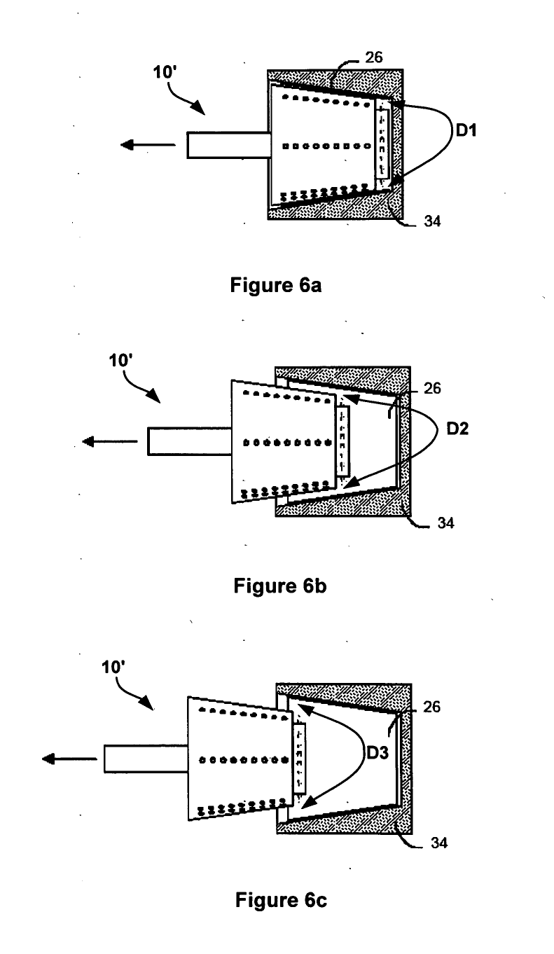

With reference to FIG. 5c (also shown in greater detail with respect to FIGS. 6a, 6b and 6c) it can be seen that, the charging power supply is then turned on and a high voltage is supplied to ionizing electrode set 20 to thereby pin one end of label 26 to mold cavity wall 34. At substantially the same moment, mandrel body 12 begins to be withdrawn from mold cavity 34. Since the high voltage is still supplied to electrodes 20, label 26 is progressively pinned to cavity wall 34 as electrodes 20 traverse substantially the entire label surface. About when electrodes 20 pass the opposite edge of label 26 (the edge closest to the outside edge of cavity 34), the charging power supply is turned off and the charging cycle is completed. Thus, the label has been electrostatically placed into the mold cavity. Withdrawal of mandrel body 12 from mold cavity 34 preferably requires a period of time that may range from about 0.25 seconds to about 2.0 seconds, depending on a number of factors such as label material thickness, charging voltages, object geometry, etc. For many typical applications, body 12 withdrawal times of about 0.5 seconds to about 1 second will prove sufficient. It will be appreciated that the inventive methods and apparatus minimize the label transfer times, because the mandrel body is removed from the cavity while the label is being pinned. By contrast, the prior art systems and methods require separate and cumulative time periods for (1) pinning a label to a cavity, and (2) withdrawing the mandrel body from the cavity. To complete formation of a labeled article, mandrel 10 may be moved away from female mold cavity 34 (FIG. 5c), male mold member 36 is used to define an enclosed injection cavity corresponding to the shape of the injection molded article (see FIG. 5d), and material is introduced to thereby form an article 40 with label 26 integrally formed therewith. Members 34 and 36 may then be retracted and article 40 removed (see FIG. 5e).

It will be appreciated that the various mandrel configurations shown and described herein generate ions around the circumference of body 12 imposing a substantially ring-shaped electrostatic field to the label/mold cavity that axially traverses the mold cavity as body 12 is extracted from the mold cavity. Since no other electrodes are present, no (or virtually no) other source of ions is present and no other electrostatic field is applied to the label/mold cavity. Thus, this ring-shaped source of ions is only applied to a relatively narrow band of the label/mold cavity at any given moment. However, the ions are applied to the entire surface of the label in response to extraction of mandrel body 12. Restated, electrodes 20 apply a substantially uniform and circumferential ionizing current to label 26 beginning in the vicinity of distal end 16 and that field preferably moves in an axial direction until the field has been applied to the opposing end of label 26.

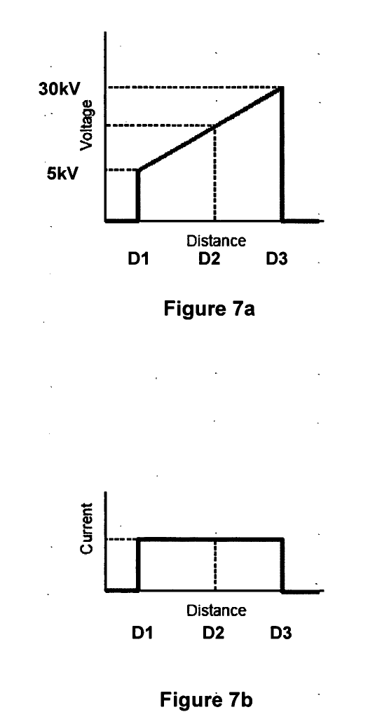

With joint reference now to FIGS. 6a, 6b, 6c, 7a and 7b, it will be appreciated that the distance (D1, D2 and D3) between the electrode tips and the concave mold surface will increase as mandrel body 12 is withdrawn from the mold/die if at least one of the mandrel body and the mold are tapered in some way. In accordance with a particularly preferred embodiment, a constant-current charging system may be used to vary the voltage applied to the electrodes 20 and to thereby maintain a constant ionizing current from the electrodes 20 to label 26 despite these varying distances. As body 12 is axially extracted from the mold cavity, the distance from the electrode tips to the mold cavity wall increases from D1, through D2 to D3 and the voltage applied to the electrodes preferably rises from about 5,000 (five-thousand) volts to as much as 30,000 (thirty-thousand) volts. In a system with a maximum charging voltage of about 30,000 (thirty-thousand) volts, and typical materials discussed herein, the distance between electrode tips and body surface around groove 16 is preferably selected such that the distance D3 from the electrode tips to the top of the label (the portion of the label closest to the outer edge of the female mold cavity) is about 1″ (one inch) as electrodes 20 pass that point of the label.

While the present invention has been described in connection with what is presently considered to be the most practical and preferred embodiments, it is to be understood that the invention is not limited to the disclosed embodiments, but is intended to encompass the various modifications and equivalent arrangements included within the spirit and scope of the appended claims. With respect to the above description, for example, it is to be realized that the optimum dimensional relationships for the parts of the invention, including variations in size, materials, shape, form, function and manner of operation, assembly and use, are deemed readily apparent to one skilled in the art, and all equivalent relationships to those illustrated in the drawings and described in the specification are intended to be encompassed by the appended claims. Therefore, the foregoing is considered to be an illustrative, not exhaustive, description of the principles of the present invention.

All of the numbers or expressions referring to quantities of ingredients, reaction conditions, etc. used in the specification and claims are to be understood as modified in all instances by the term “about.” Accordingly, the numerical parameters set forth in the following specification and attached claims are approximations that can vary depending upon the desired properties, which the present invention desires to obtain.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

1. A method of manufacturing a molded article with an integrally formed label on a surface thereof, comprising:
(a) providing an electrostatic mandrel comprising a body, with a surface, a first end and an opposite distal end, and plural ionizing electrodes only in the vicinity of the distal end of the mandrel body;
(b) securing a label to the surface of the body;
(c) positioning the body with the secured label at least partially within a female mold cavity;
(e) releasing the label from the body;
(d) supplying high voltage to the electrodes while withdrawing the body from the mold cavity to thereby progressively pin the label to the part of the mold cavity in the vicinity of the ionizing electrodes until substantially the entire label has been pinned to the mold cavity;
(f) withdrawing the mandrel away from the mold cavity;
(g) enclosing the mold cavity to define an enclosed mold cavity corresponding to the shape of the molded article; and
(h) introducing material into the enclosed mold cavity to thereby form an article with the label integrally formed therewith.

2. The method of claim 1, wherein the step of withdrawing the mandrel from the mold cavity lasts for a period of about 0.25 to 2.0 seconds.

3. The method of claim 2, wherein the step of withdrawing the mandrel from the mold cavity lasts for a period of about 0.5 to 1 second.

4. The method of claim 1, wherein the step of providing further comprises providing an axis-defining mandrel body that tapers inwardly toward the axis from the first end to the distal end, further comprises providing a groove disposed in the mandrel body, near the distal end of the body and in a plane that is at least substantially perpendicular to the axis.

5. The method of claim 4, wherein the step of supplying comprises applying a varying voltage to the electrodes to thereby maintain a substantially constant ionizing current.

6. The method of claim 5, wherein the step of supplying further comprises applying to the electrodes a voltage that varies between about 5,000 volts to about 30,000 volts depending on the distance between the tips of the electrodes and the mold surface.

7. The method of claim 1, wherein the step of providing plural ionizing electrodes only in the vicinity of the distal end of the mandrel body consists essentially of providing plural ionizing electrodes at the distal end of the mandrel body.

8. The method of claim 1, wherein the step of providing further comprises providing an axis-defining mandrel body that tapers inwardly toward the axis from the first end to the distal end and at least one recess disposed at the distal end of the mandrel body, wherein at least one ionizing electrode is disposed within the recess.

9. The method of claim 1, wherein the step of providing further comprises providing an axis-defining mandrel body that tapers inwardly toward the axis from the first end to the distal end, and wherein the plural ionizing electrodes comprise an electrode assembly cartridge removably affixed to the distal end of the mandrel body.

10. An electrostatic mandrel capable of positioning a label in a mold cavity and of receiving a variable high voltage from a power supply comprising: an axis-defining body with a first end and an opposite distal end, and a set of ionizing electrodes disposed only in the vicinity of the distal end of the body and comprising plural ionizing electrodes with ionizing tips.

11. The electrostatic mandrel of claim 10, further comprising means for delivering the variable high voltage to the set of electrodes such that the electrodes may emit a substantially constant ionizing current even if the distance between the ionizing tips and the mold cavity varies.

12. The electrostatic mandrel of claim 11, wherein the means for delivering comprises an electrode bus that resistively couples the set of electrodes to the high voltage power supply.

13. The electrostatic mandrel of claim 11, wherein the mandrel body is shaped as a truncated cone, the means for delivering comprises resistive coupling, the set of ionizing electrodes is disposed within a single groove, and the groove encircles the circumference of the mandrel in the vicinity of the distal end such that a label covers the electrodes when the label is placed around the body.

14. The electrostatic mandrel of claim 10, wherein the mandrel further comprises vacuum ports extending through the body and connected to plural vacuum holes disposed on the surface of the body, and wherein no vacuum holes are located between any adjacent ones of the ionizing electrodes.

15. The electrostatic mandrel of claim 10, wherein the set of electrodes is disposed on an electrode assembly cartridge that is removably affixed to the distal end of the mandrel body.

16. The electrostatic mandrel of claim 15, wherein the set of ionizing electrodes is disposed within a single groove, the groove comprises a circumferential groove and wherein the electrodes may be resistively coupled to a constant-current ionizing power supply.

17. The electrostatic mandrel of claim 10, wherein the electrodes terminate at electrode tips, and the ionizing electrode tips are about one-quarter inch from the surface of the mandrel body.

18. The electrostatic mandrel of claim 17, wherein the set of ionizing electrodes is disposed within a single groove, the electrodes terminate at electrode tips, and the ionizing electrode tips are between about one-eighth inch to about 1 inch from the surface of the mandrel body in the vicinity of the groove.

19. The electrostatic mandrel of claim 10, wherein the set of ionizing electrodes consists essentially of plural ionizing electrodes disposed in the vicinity of the distal end of the body.

20. The electrostatic mandrel of claim 10, wherein the set of ionizing electrodes consists of plural ionizing electrodes disposed at the distal end of the body.

21. The electrostatic mandrel of claim 10, wherein the electrodes terminate at electrode tips, and each ionizing electrode tip is spaced from adjacent tips by about 0.1 inch to about 1 inch.

22. The electrostatic mandrel of claim 10, wherein the electrodes terminate at electrode tips, the set of ionizing electrodes is disposed within a single groove, and the ionizing electrode tips are spaced within the groove to provide a substantially uniform ionizing current around the circumference of the cross-section of the body.

23. The electrostatic mandrel of claim 10, wherein the set of electrodes comprises plural resistively-coupled electrodes.

24. The electrostatic mandrel of claim 22, wherein the cross-sectional shape of the mandrel body taken perpendicular to the axis of the mandrel in the vicinity of the electrodes is substantially the same shape as that defined by the electrode tips.

25. The electrostatic mandrel of claim 10, wherein the means for delivering voltage to the electrodes comprises a bus that is electrically coupled to a source of high voltage via a single resistor.

26. The electrostatic mandrel of claim 11, wherein each of the ionizing electrodes comprises an electrode pin disposed on a substrate and wherein the means for delivering the high voltage comprises a bus that is electrically coupled to a source of high voltage and coupled to each emitter pin via one resistor disposed on the substrate.

27. The electrostatic mandrel of claim 10, wherein the ionizing electrodes are coupled in groups to a single bus through resistors on multiple separate substrates.

28. The electrostatic mandrel of claim 11, wherein the set of ionizing electrodes comprise plural electrode pins affixed to a substrate.

29. A method of electrostatically applying a label to a mold cavity, comprising:
(a) providing an electrostatic mandrel comprising a body, with a surface, a first end and an opposite distal end, and plural ionizing electrodes only in the vicinity of the distal end of the mandrel body;
(b) securing a label to the surface of the body;
(c) positioning the body with the secured label at least partially within a female mold cavity;
(d) releasing the label from the body; and
(e) applying a varying voltage to the electrodes to thereby maintain a constant ionizing current while withdrawing the mandrel body from the mold cavity to thereby progressively pin the label to the part of the mold cavity in the vicinity of the ionizing electrodes until substantially the entire label has been pinned to the mold cavity.

30. The method of claim 29, wherein the step of applying further comprises maintaining a constant ionizing current across the distance between the mandrel and the mold cavity while withdrawing the mandrel from the mold cavity.

31. The method of claim 29, wherein the step of providing further comprises providing at least one recess disposed in the mandrel body and at the distal end of the body.

32. The method of claim 29 wherein the step of applying further comprises applying to the electrodes a voltage that varies between about 5,000 volts to about 30,000 volts depending on the distance between the tips of the electrodes and the mold surface, whereby the ionizing current remains substantially constant.

33. The method of claim 29, wherein the step of providing plural ionizing electrodes consists essentially of providing plural ionizing electrodes at the distal end of the mandrel body.

34. The method of claim 29, wherein the plural ionizing electrodes comprise an electrode assembly cartridge removably affixed to the distal end of the mandrel body.

35. An electrode assembly cartridge for use with an electrostatic mandrel body having a distal end and being capable of positioning a label in a mold cavity comprising:
at least one resistor;
at least one substrate;
plural ionizing electrode pins; and
means for delivering a varying voltage to the ionizing electrode pins, wherein the electrode pins are affixed to the at least one substrate with multiple ones of the electrode pins electrically coupled to the means for delivering via the at least one resistor.

36. The electrode assembly cartridge of claim 35 wherein the means for delivering comprises a bus electrically coupling the electrodes to the resistor.

37. The electrode assembly cartridge of claim 35 further comprising means for removably affixing the cartridge to the distal end of the mandrel body.

38. The electrode assembly cartridge of claim 35 wherein the at least one resistor is disposed on the at least one substrate.

39. The electrode assembly cartridge of claim 38 wherein the means for delivering comprises one bus that is electrically coupled to all of the plural electrodes pins via respective separate ones of the resistors and substrates.

40. The electrode assembly cartridge of claim 38 wherein
the means for delivering comprises a bus
there are multiple substrates,
the ionizing electrodes are disposed on the multiple substrates in groups, and
each electrode group is electrically coupled to the bus ring via at least one resistor.

41. The electrode assembly cartridge of claim 35 wherein the means for delivering comprises a bus the ionizing electrodes pins are disposed on one substrate in groups, and each group of the electrode pins is electrically coupled to the bus via a resistor.

42. An electrostatic mandrel capable of positioning a label in a mold cavity comprising:
a body with a first end and an opposite distal end, the body being capable of receiving a label and fitting within the mold cavity; and
means, disposed only in the vicinity of the distal end of the body, for emitting an ionizing current while withdrawing the body from the mold cavity to thereby progressively pin a received label to the mold cavity in the vicinity of the means until substantially the entire label has been pinned to the mold cavity.

43. The electrostatic mandrel of claim 42, further comprising means for removably affixing the means for emitting an ionizing current to the mandrel body.

44. The electrostatic mandrel of claim 42, wherein the means for emitting an
ionizing current comprises:
at least one substrate;
means for delivering a varying high voltage; and
plural ionizing electrode pins affixed to the at least one substrate with multiple ones of the electrode pins electrically coupled to the means for delivering via at least one resistor.

45. The electrostatic mandrel of claim 44, wherein the means for delivering comprises a bus electrically coupling the electrodes to the resistor such that a varying voltage may be delivered to the electrodes through the bus and the resistor.

46. The electrostatic mandrel of claim 44, wherein the means for delivering comprises a bus the ionizing electrodes pins are disposed on one substrate in groups and each group of the electrode pins is electrically coupled to the bus via at least one resistor.
